(19) United States
(12) Patent Application Publication
(10) Pub. No.: US 2012/0210799 A1
(43) Pub. Date: Aug. 23, 2012

(54) FORCE DETECTOR

(75) Inventor: Hisao MOTOYAMA, Minamisoma (JP)

(73) Assignee: SEIKO EPSON CORPORATION, Tokyo (JP)

(21) Appl. No.: 13/366,752

(22) Filed: Feb. 6, 2012

(30) Foreign Application Priority Data
Feb. 18, 2011 (JP) 2011-033921

(51) Int. Cl. G01L 7/08

(52) U.S. Cl. 73/716; 73/715

(57) ABSTRACT

A force detector includes: a container which has a cylindrical external shape; a diaphragm which is disposed on an end surface of the container; a force detection element which has a force detection unit and a pair of bases connected with one and the other ends of the force detection unit, respectively, and detects a force generated by the shift of the diaphragm with the detection axis extending in the direction parallel with the line connecting the bases under the condition in which the one and the other bases are connected with the diaphragm and the container, respectively; and a flange which projects from the side surface of the container in the direction toward the outer circumferential side of the side surface such that the flange becomes concentric with the outer circumference of the side surface of the container.

### BACKGROUND

1. Technical Field

The present invention relates to a force detector, and more particularly to a force detector capable of reducing deterioration of its diaphragm deformation sensitivity caused by fixation between the force detector and an external case via a flange.

2. Related Art

It has known to provide a force detector (pressure sensor) such as a water-pressure gauge, a barometer, and a differential pressure gauge with a piezoelectric oscillator as a force detection element. When a pressure is applied to the piezoelectric oscillator in the direction of the detection axis, the pressure sensor provided with the piezoelectric oscillator detects the applied pressure to the pressure sensor based on the change of the resonance frequency of the piezoelectric oscillator produced thereby.

In each of JP-A-2010-019826 and JP-A-2010-019827, there is disclosed a pressure sensor which detects the difference between a measurement target pressure and a reference pressure.

FIGS. 17A and 17B schematically illustrate a pressure sensor disclosed in JP-A-2010-019826. FIG. 17A is a perspective view of the disassembled pressure sensor, while FIG. 17B is a cross-sectional view of the pressure sensor. As can be seen from FIGS. 17A and 17B, a pressure sensor 200 has a diaphragm 204A and a diaphragm 204B at one end and the other end of a cylindrical housing 202, respectively. A flange 410 is provided at one end of the side surface of the housing 202. The diaphragm 204A and the diaphragm 204B are connected by a center shaft 206. One end of a pressure sensitive element 208 (force detection element) in the longitudinal direction is attached to the housing 202, while the other end of the pressure sensitive element 208 is attached to the center shaft 206. The center shaft 206 shifts in the direction of the resultant force of the pressures applied to the diaphragm 204A and the diaphragm 204B.

According to this structure, the pressure sensitive element 208 receives a compressing stress or an expanding stress in the longitudinal direction as a result of the shift of the center shaft 206, and detects which of the pressures applied to the diaphragm 204A and the diaphragm 204B is larger and the levels of these pressures (relative pressures) based on the received stress. Therefore, this structure can achieve detection of a measurement target pressure based on a reference pressure environment. A similar structure is also disclosed in JP-A-2010-019827. This type of pressure sensor measuring relative pressures requires a structure which separates the pressure environment of one diaphragm from the pressure environment of the other diaphragm.

FIG. 18 schematically illustrates a pressure sensor disclosed in JP-UM-B-05-019797. According to the technology shown in this reference, circular rings 306 (O-rings) are attached such that the areas around the outer edges of both the main surfaces of an element 304 provided with a diaphragm 302 can be held between the circular rings 306. Furthermore, the element 304 is sandwiched between an external case 308 and an external case 310 both capable of accommodating the element 304, and held by these cases 308 and 310 in the normal direction of the element 304. In this condition, the element 304 provided with the diaphragm 302 is pinched by the circular rings 306 fastened by the external case 308, the external case 310, and the element 304. According to this structure, an internal space 308a on the external case 308 side with respect to the diaphragm 302 is separated from an internal space 310a on the external case 310 side.

The external case 308 has a pressure introduction port 308b connecting with the internal space 308a, while the external case 310 has a pressure introduction port 310b connecting with the internal space 310. In this case, a pressure sensor 300 can detect the pressure difference between different pressure environments produced on the front side and the rear side of the diaphragm 302 by connection with the different pressure environments through the pressure introduction port 308b and the pressure introduction port 310b. Similar technologies are disclosed in JP-UM-A-06-046339 and JP-A-2003-083829. Furthermore, Japanese Patent No. 3,693,890 proposes a technology which holds a flange via gaskets such that the flange can be sandwiched therebetween in place of the circular rings (O-ring) and separates the pressure environment on one surface of the element from the pressure environment on the other surface of the element.

FIG. 19 schematically illustrates a pressure sensor according to JP-A-2010-019826 accommodated in an external case. FIG. 20 schematically illustrates the pressure sensor according to JP-A-2010-019826 accommodated in the external case in the condition of use. The pressure sensor disclosed in JP-A-2010-019826 can separate pressure environments of two diaphragms from each other by a method similar to any of JP-UM-B-05-019797, JP-UM-A-06-046339, JP-A-2003-083829, and Japanese Patent No. 3,693,890.

More specifically, an external case 400 accommodating the pressure sensor 200 includes a first external case 402 which has a concave 402a accommodating the area of the pressure sensor 200 around the diaphragm 204A, and a second external case 404 which has a concave 404a accommodating the area of the pressure sensor 200 around the diaphragm 204B. The bottom of the concave 404a of the first external case 402 has a pressure introduction port 402b, while the concave 404a of the second external case 404 has an opening hole 404b.

There is further provided a cylindrical screw fitting 406 which has an insertion hole 406a having a size equal to or larger than the diameter of the housing 202 and equal to or smaller than the diameter of the flange 410 such that the housing 202 can be inserted through the insertion hole 406a into contact with the flange 410. The screw fitting 406 has a male screw 406b on the outer side wall thereof for engagement with female screws 402c and 404c formed on the inner walls of the first external case 402 and the second external case 404 when accommodated in the respective external cases 402 and 404. A circular ring 408 (O-ring) is disposed on the diaphragm 204A side surface of the flange 410. On the other hand, a circular ring 409 (O-ring) is disposed on the diaphragm 204B side surface of the flange 410.

Under the condition of engagement between the screw fitting 406 and the first external case 402, the circular ring 408 is brought into press contact with the flange 410 and the bottom surface of the concave 402a of the first external case 402. Simultaneously, the circular ring 409 is brought into press contact with the flange 410 and the screw fitting 406, whereby the flange 410 is sandwiched between the circular ring 408 and the circular ring 409. Under this condition, the second external case 404 is fitted to the screw fitting 406. According to this structure, the pressure sensor 200 can be accommodated in the external case 400 with an internal space 412 in the first external case 402 and an internal space 414 in the second external case 404 separated from each other via the circular ring 408 and the circular ring 409. For example, the relative-pressure type pressure sensor 200 disclosed in JP-A-2010-019826 is used for detection of the quantity of underground water based on the detection of the water pressure of the underground water as illustrated in FIG. 20. In this case, the pressure sensor 200 accommodated in the external case 400 detects the pressure of the underground water based on the difference between the pressure of the underground water introduced through the pressure introduction port 402b and brought into contact with the diaphragm 204A, and the atmospheric pressure introduced (via a junction box 418) through a tube 416 attached to the opening hole 404b of the external case 400 and brought into contact with the diaphragm 204B.

However, the following problems arise from the related-art technology. According to this structure, the inside of the external case 400 and the flange 410 of the pressure sensor 200 are fixed via the circular ring 408 and the circular ring 409. In this case, distortion (internal stress) is produced by the fixation of the flange 410. This distortion has an adverse effect on the sensitivity for detecting the pressures applied to the diaphragms 204A and 204B, thereby producing errors of the detected measurement target pressure. Moreover, according to the findings of the present inventors, the zero point of the pressure shifts when the pressure sensor 200 is removed from the external case 400 and again inserted into the external case 400.

### SUMMARY

An advantage of some aspects of the invention is to provide a force detector capable of reducing deterioration of diaphragm deformation sensitivity caused by fixation between the force detector and an external case via a flange and obtaining a stable physical quantity.

### Application Example 1

This application example of the invention is directed to a force detector including: a container which has a cylindrical external shape; a diaphragm which is disposed on an end surface of the container and shifts toward the inside or outside of the container when receiving a force; a force detection element which has a force detection unit and a pair of bases connected with one and the other ends of the force detection unit, respectively, and detects a force generated by the shift of the diaphragm with detection axis extending in the direction parallel with the line connecting the bases under the condition in which the one and the other bases are connected with the diaphragm and the container, respectively; and a flange which projects from the side surface of the container in the direction toward the outer circumferential side of the side surface such that the flange becomes concentric with the outer circumference of the side surface of the container. The flange is disposed in such a position that the end surface of the container on which the diaphragm is provided projects in the thickness direction of the flange from the position of the flange. According to this structure, the distance between the flange and the diaphragm becomes larger than the corresponding distance of a structure in which the flange is disposed in the plane leveled with the diaphragm. In this case, a stress generated by the hold of the flange decreases by the time when the stress reaches the diaphragm. Thus, the force detector can reduce deterioration of the diaphragm deformation sensitivity caused by the fixation between the force detector and an external case via the flange, and provide stable physical quantities.

### Application Example 2

This application example of the invention is directed to the force detector of Application Example 1, wherein the force detection element is disposed in such a position that the direction of the detection axis extends in parallel with the shift direction of the diaphragm.

According to this structure, the force detection element can directly receive a force produced by the shift of the diaphragm. Thus, the sensitivity of the force detector increases.

### Application Example 3

This application example of the invention is directed to the force detector of Application Example 1 or 2, which further includes: a second diaphragm disposed on the container at a position opposed to the diaphragm; and a force transmitting member which connects the diaphragm and the second diaphragm and shifts in the direction of the resultant force of a force received from the diaphragm and a force received from the second diaphragm. The one base of the force detection element is connected with the force transmitting member.

According to this structure, the force detector can measure the relative physical quantity between the diagram and the second diaphragm.

### Application Example 4

This application example of the invention is directed to the force detector of Application Example 3, wherein the flange is disposed at the center of the side surface.

According to this structure, the distance between the flange and the diaphragm becomes equal to the distance between the flange and the diaphragm further provided on the end surface of the container opposed to the diaphragm. In this case, the stress generated by the hold of the flange is not one-sidedly transmitted toward one of the diaphragms. Moreover, since the flange is disposed at the center of the side surface of the container, the stress produced by the hold of the flange can be sufficiently decreased by the time when reaching the respective diaphragms. Thus, the force detector can highly accurately reduce deterioration of the diaphragm deformation sensitivity caused by fixation between the force detector and the external case via the flange.

### Application Example 5

This application example of the invention is directed to the force detector of Application Example 3, wherein the container includes a cylindrical side wall which forms the side surface and has an opening on each of both the ends of the side wall, and a first cover and a second cover each of which forms the corresponding end surface and seals the corresponding opening. The diaphragm is disposed on the first cover. The second diaphragm is disposed on the second cover. The flange is disposed on the side surface of either the first cover or the second cover, and is disposed in such a position that the end surface formed by the cover where the diaphragm is disposed projects in the thickness direction of the flange from the position of the flange.

According to this structure, the entire strength of the force detector can be maintained. Moreover, the volume of the clearance between the force detector and the external case can be decreased, whereby the air remaining in the clearance can be easily discharged to the outside at the time of introduction of the force detector into liquid. Accordingly, reduction of pressure measurement errors can be achieved.

### Application Example 6

This application example of the invention is directed to the force detector of any one of Application Examples 1 to 5, wherein the diameter of the outer circumference of the side surface on the side of the one surface of the flange is different from the diameter of the outer circumference of the side surface on the side of the other surface of the flange opposed to the one surface of the flange.

Generally, the design of the diameter of a diaphragm contacting the physical quantity measurement environment varies according to the size and environment of the physical quantity to be measured. In this case, the diameter of the cover to which the diaphragm is attached changes accordingly. According to the structure of this aspect, however, the diaphragm contacting the reference environment is constituted by a component having a standardized size. Thus, the cost of the force detector can be reduced even when the diaphragm design is varied for each measurement environment.

### Application Example 7

This application example of the invention is directed to the force detector of Application Example 6, which further includes a first circular ring contacting the one surface of the flange, and a second circular ring contacting the other surface of the flange. The sum of the radius of the cross section of the first circular ring and the radius of the container on the side of the one surface of the flange is equal to the sum of the radius of the cross section of the second circular ring and the radius of the container on the side of the other surface of the flange. According to this structure, the center of the cross section of the first circular ring and the center of the cross section of the second circular ring are opposed to each other with the flange interposed between the centers. Thus, a stress which bends the whole cover and the whole diaphragm generated by the hold of the flange can be reduced.

### Application Example 8

This application example of the invention is directed to the force detector of any one of Application Examples 1 to 7, which further includes an external case which accommodates the container and has a pressure introduction port at a position opposed to the diaphragm. The external case has a discharge port extended from the side surface of the external case to a junction position with the pressure introduction port. According to this structure, the air remaining between the external case and the force detector at the time of introduction of the force detector into liquid can be efficiently discharged.

### BRIEF DESCRIPTION OF THE DRAWINGS

The invention will be described with reference to the accompanying drawings, wherein like numbers reference like elements.

FIG. 1 is a perspective view of a force detector according to a first embodiment (cross-sectional view taken along the YZ plane).

FIGS. 2A and 2B are cross-sectional views of the force detector according to the first embodiment, wherein: FIG. 2A is a cross-sectional view taken along the XZ plane; and FIG. 2B is a cross-sectional view taken along the YZ plane.

FIG. 3 is a perspective view of the force detector and an external case for accommodating the force detector in a disassembled condition according to the first embodiment.

FIG. 4 is a perspective view of the force detector accommodated in the external case in the first embodiment.

FIG. 5 is a cross-sectional view of the force detector accommodated in the external case in the first embodiment.

FIGS. 6A and 6B are cross-sectional views of a force detector according to a second embodiment, wherein: FIG. 6A is a cross-sectional view taken along the XZ plane; and FIG. 6B is a cross-sectional view taken along the YZ plane.

FIG. 7 is a cross-sectional view of a force detector and an external case (taken along the XZ plane) where the diameter of a first outer circumferential portion is larger than the diameter of a side wall according to a third embodiment.

FIG. 8 is a cross-sectional view of the force detector and the external case (taken along the XZ plane) where the diameter of the first outer circumferential portion is smaller than the diameter of the side wall according to the third embodiment.

FIGS. 9A and 9B are cross-sectional views of a force detector according to a fourth embodiment, wherein: FIG. 9A is a cross-sectional view taken along the XZ plane; and FIG. 9B is a cross-sectional view taken along the YZ plane.

FIG. 10 is a cross-sectional view of a force detector according to a modified example of the fourth embodiment.

FIGS. 11A and 11B are cross-sectional views of a force detector according to a fifth embodiment, wherein: FIG. 11A is a cross-sectional view taken along the XZ plane; and FIG. 11B is a cross-sectional view taken along the YZ plane.

FIG. 12 shows the change of the pressure value of a force detector in a related art produced after attachment and detachment of the force detector to and from an external case at each predetermined environmental temperature, wherein: the vertical axis indicates the amount of change (%); and the horizontal axis indicates applied pressure (kPa). The environmental temperature is set at −10° C., +10° C., +25° C., and +50° C.

FIGS. 13A through 13C show the change of the resonance frequency (change of pressure value) of the force detector in the related art with an elapse of time after attachment and detachment of the force detector to and from the external case for each thickness of the flange, wherein: FIG. 13A corresponds to the 3 mm thick flange; FIG. 13B corresponds to the 4 mm thick flange; and FIG. 13C corresponds to the 6.5 mm thick flange. In FIGS. 13A through 13C, the vertical axis indicates the frequency (Hz), while the horizontal axis indicates time (a.u.).

FIG. 14 shows a comparison between the force detector in the embodiments and the force detector in the related art in regard to the change of the resonance frequency (pressure value) of the sensor after attachment and detachment of the force detector to and from the external case. In FIG. 14, the vertical axis indicates the amount of frequency change (Hz), while the horizontal axis indicates the thickness of the flange (mm).

FIGS. 15A through 15D show the change of the pressure value after attachment and detachment of the force detector in the embodiments at each predetermined temperature when the force detector is repeatedly attached to and detached from the external case. FIG. 15A corresponds to the change resulting from the attachment and detachment performed once. FIG. 15B corresponds to the change resulting from the attachment and detachment performed twice. FIG. 15C corresponds to the change resulting from the attachment and detachment performed three times. FIG. 15D corresponds to the change resulting from the attachment and detachment performed four times. In each of FIGS. 15A through 15D, the vertical axis indicates the amount of change (%), while the horizontal axis indicates the applied pressure (100 Pa). In the respective figures, the environmental temperature of the force detector is set at −10° C., +10° C., +30° C., and +50° C.

FIGS. 16A through 16D show the hysteresis characteristics of the force detector in the embodiments when the force detector is attached to and detached from the external case three times. FIG. 16A corresponds to the result at the environmental temperature of the force detector set at −10° C. FIG. 16B corresponds to the result at the environmental temperature of +10° C. FIG. 16C corresponds to the result at the environmental temperature of +30° C. FIG. 16D corresponds to the result at the environmental temperature of +50° C. In each of FIGS. 16A through 16D, the vertical axis indicates the amount of change (%), while the horizontal axis indicates the applied pressure (Pa).

FIGS. 17A and 17B schematically illustrate a pressure sensor disclosed in JP-A-2010-019826, wherein: FIG. 17A is a perspective view in a disassembled condition; and FIG. 17B is a cross-sectional view.

FIG. 18 schematically illustrates a pressure sensor disclosed in JP-UM-B-05-019797.

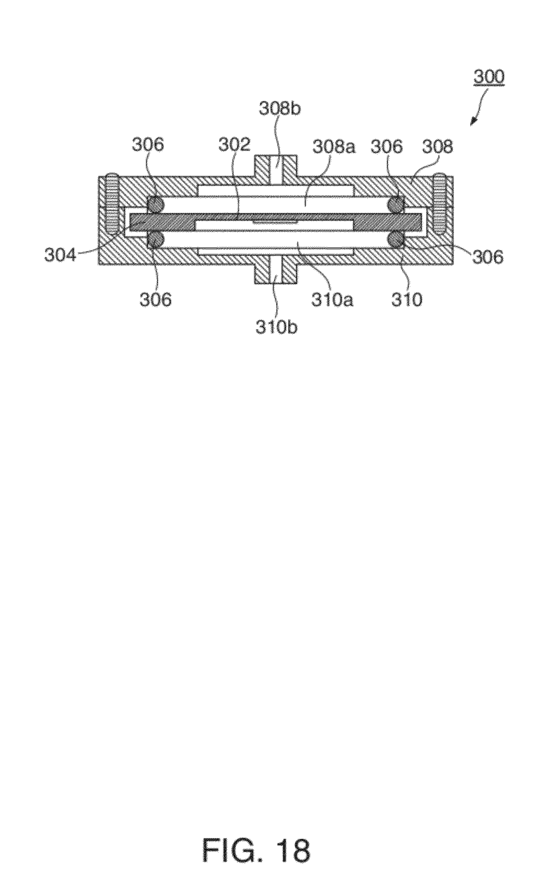

FIG. 19 schematically illustrates the pressure sensor shown in JP-A-2010-019826 accommodated in an external case.

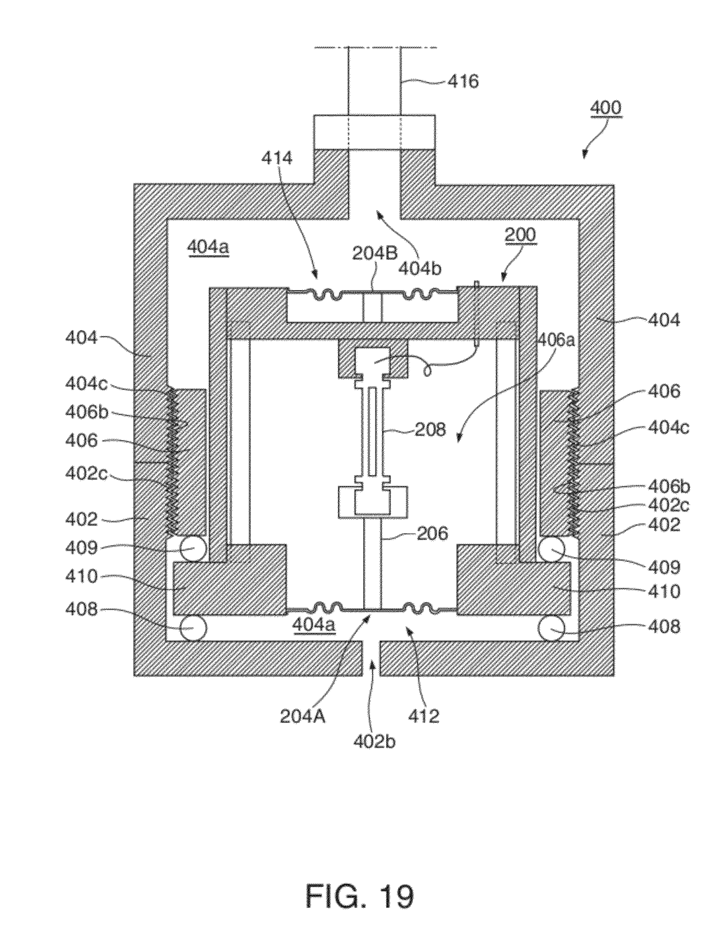

FIG. 20 schematically illustrates the pressure sensor shown in JP-A-2010-019826 accommodated in the external case in the condition of use.

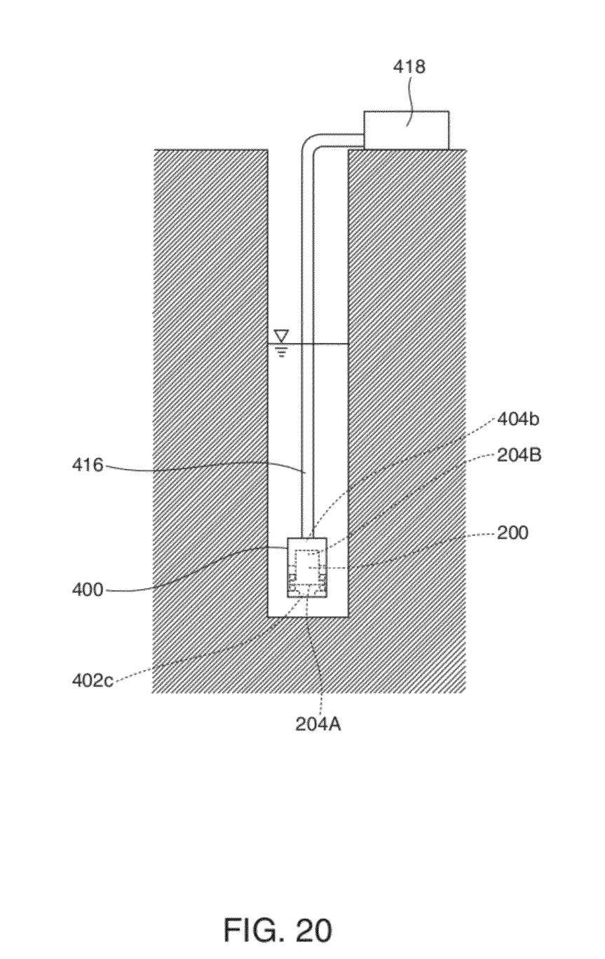

### DESCRIPTION OF EXEMPLARY EMBODIMENTS

A force detector according to exemplary embodiments of the invention is hereinafter described in detail with reference to the drawings. The constituent elements, types, combinations, shapes, relative positions and the like shown in the following description are not provided as features for limiting the scope of the invention but as only examples when not particularly specified otherwise. The X axis, Y axis, and Z axis shown in the respective figures correspond to axes in a rectangular coordinate system.

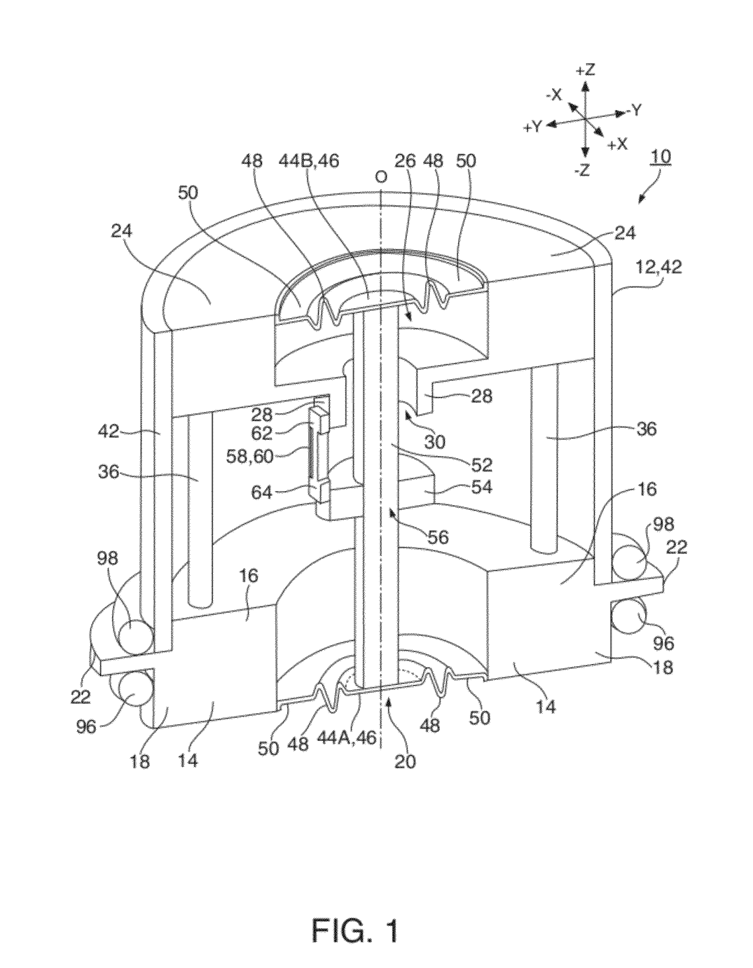

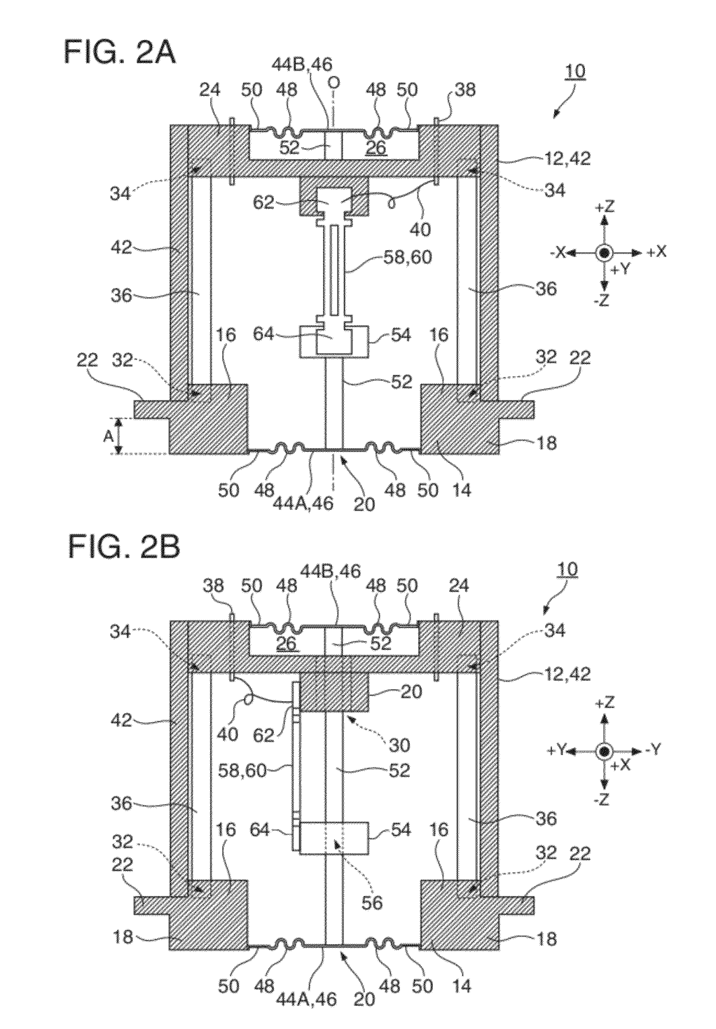

FIG. 1 is a perspective view of a force detector according to a first embodiment (cross-sectional view taken along the YZ plane). FIGS. 2A and 2B are cross-sectional views of the force detector in the first embodiment. More specifically, FIG. 2A is a cross-sectional view taken along the XZ plane, while FIG. 2B is a cross-sectional view taken along the YZ plane. As illustrated in FIG. 1, a force detector 10 according to the first embodiment has a cylindrical shape with its center axis located on a line segment O. The force detector 10 includes a housing 12, a diaphragm 44A, and a diaphragm 44B constituting a container which airtightly seals its internal space. The force detector 10 is further provided with a force detection element 58, support shafts 36, a center shaft 52 functioning as a force transmitting member, and others within the storage space of the container having the diaphragm 44A and the diaphragm 44B. As will be explained later, the force detector 10 detects a relative physical quantity based on the force difference between the pressure received by the diaphragm 44A and the physical quantity (pressure) received by the diaphragm 44B (second diaphragm) by using the force detection element 58. The interior of the container is evacuated and sealed. The housing 12 constituting a part of the container of the force detector 10 includes a circular first cover 14 (diaphragm 44A), a circular second cover 24 (diaphragm 44B), the support shafts 36, and a cylindrical side wall 42. The first cover 14 has a first outer circumferential portion 16 having a side surface in contact with the −Z axis side wall surface of the inner wall of the cylindrical side wall 42, a second outer circumferential portion 18 in contact with the −Z axis side end of the side wall 42, and an opening 20 through which the first outer circumferential portion 16 and the second outer circumferential portion 18 communicate with each other, all of which portions and opening 16, 18, and 20 are concentrically disposed. A flange 22 is connected with the second outer circumferential portion 18 on the side wall 42 side. The flange 22 provided on the second outer circumferential portion 18 forming the side surface of the housing 12 projects in the direction toward the outer circumferential side of the second outer circumferential portion 18 to form a shape concentric with the outer circumference of the second outer circumferential portion 18 in the plan view (as viewed in the Z axis). The flange 22 is connected with the +Z axis side portion of the first cover 14, i.e., the side wall 42 side surface of the second outer circumferential portion 18 into one piece body to form a surface leveled with the side wall 42 side surface of the second outer circumferential portion 18. According to this structure, the −Z axis side end surface of the second outer circumferential portion 18 where the diaphragm 44A is disposed projects from the flange 22 by a distance A in the thickness direction of the flange 22 (Z axis direction) as illustrated in FIGS. 2A and 2B. The diameter of the second outer circumferential portion 18 is the same as the diameter of the side wall 42. In this case, the diameter of the first outer circumferential portion 16 is smaller than the diameter of the second outer circumferential portion 18 by the length corresponding to the thickness of the side wall 42. The second outer circumferential portion 18 contacts the environment of a physical quantity measurement target (pressure measurement target), which will be described later. The side surface of the second cover 24 has an outer shape which has a diameter sufficient for contacting the inner wall of the side wall 42, and connects with the +Z axis side wall surface of the inner wall of the side wall 42. The second cover 24 has a concave 26 formed in the +Z axis side surface thereof in such a shape as to be concentric with the second cover 24. The opening of the concave 26 is sealed by the diaphragm 44B. In this arrangement, the +Z axis side end surface of the second cover 24 where the diaphragm 44B is disposed projects from the flange 22 in the thickness direction of the flange 22 (Z axis direction).

The second cover 24 further has a boss 28 disposed on the −Z axis side surface thereof in such a shape as to be concentric with the second cover 24, and an insertion hole 30 through which the boss 28 and the concave 26 communicate with each other in the Z axis direction and through which the center shaft 52 (described later) is inserted. The boss 28 is the part to which the force detection element 58 is connected. It is preferable that the boss 28 having a circular shape as viewed in the Z axis direction has a flat surface at the position connecting with a first base 62 of the force detection element 58. The boss 28 may have a polygonal shape such as a rectangular shape as viewed in the Z axis direction.

The surface of the first outer circumferential portion 16 of the first cover 14 on the side facing to the second cover 24 has holes 32 to which the support shafts 36 are fitted. Similarly, the surface of the second cover 24 on the side facing to the first cover 14 has holes 34 to which the support shafts 36 are fitted. Thus, the holes 32 are disposed to be opposed to the corresponding holes 34. By engagement between the support shafts 36 and the holes 32 and 34, the first cover 14 and the second cover 24 are connected with each other via the support shafts 36.

Each of the support shafts 36 is a bar-shaped component having a certain degree of rigidity and lengthened in the ±Z axis direction. Each of the support shafts 36 disposed within the container constituted by the housing 12, the diaphragm 44A, and the diaphragm 44B produces a constant degree of rigidity between the first cover 14, the support shaft 36, and the second cover 24 by engagements between the one end of the support shaft 36 and the hole 32 of the first cover 14 and between the other end of the support shaft 36 and the hole 34 of the second cover 24. While the plural support shafts 36 are used in this embodiment, the number of the support shafts 36 may be arbitrarily determined according to the design of the respective holes.

A hermetic terminal 38 is further attached to the second cover 24. The hermetic terminal 38 is a terminal through which alternating voltage is applied to an electrode unit (not shown) of the force detection element 58 to oscillate the force detection element 58. The hermetic terminal 38 electrically connects the force detection element 58 with an IC (integrated circuit, not-shown) attached to the outside surface of the housing 12 or disposed outside and away from the housing 12 via a wire 40. While the one hermetic terminal 38 is shown in FIGS. 2A and 2B, the number of the hermetic terminals 38 attached to the second cover 24 is determined in correspondence with the total number of the electrode unit (not shown) of the force detection element 58.

The cylindrical side wall 42 is designed such that its inside diameter becomes equal to the diameter of the first outer circumferential portion 16 of the first cover 14 and the diameter of the second cover 24. According to this structure, the housing 12 is sealed by connections between the −Z axis side end of the side wall 42 and the flange 22 (second outer circumferential portion 18), between the −Z axis side wall surface of the inner wall of the side wall 42 and the side surface of the first outer circumferential portion 16, and between the +Z axis side wall surface of the inner wall of the side wall 42 and the side surface of the second cover 24. It is preferable that the first cover 14, the second cover 24, and the side wall 42 are made of metal such as stainless steel. It is also preferable that the support shafts 36 are made of ceramic or others having a certain degree of rigidity and a small thermal expansion coefficient.

Each of the diaphragms 44A and 44B has a pressure receiving surface which corresponds to one main surface facing to the outside of the housing 12 and provided with a deforming portion 48. The deforming portion 48 deforms when the pressure receiving surface receives a force (pressure) of a pressure measurement target environment (such as liquid). When the deforming portion 48 deforms toward the inside or outside of the housing 12 (Z axis direction), a compressing force or a pulling force in the Z axis direction reaches the force detection element 58. Each of the diaphragms 44A and 44B has a center portion 46 which shifts when receiving a force (pressure) from the outside, and the deforming portion 48 disposed on the outer circumference of the center portion 46 to deform in response to the force given from the outside and allow the shift of the center portion 46. Each of the diaphragms 44A and 44B has a circumferential portion 50 provided on the outer circumference of the deforming portion 48. The circumferential portion 50 of the diaphragm 44A connects with the −Z axis side end of the opening 20 of the first cover 14. The circumferential portion 50 of the diaphragm 44B is joined and fixed to the opening of the concave of the second cover 24. It is assumed that the circumferential portion 50 of each of the diaphragms 44A and 44B in an ideal condition does not deform when receiving a pressure. It is also assumed that the center portion 46 of each of the diaphragms 44A and 44B does not deform when receiving a pressure.

It is preferable that each of the diaphragms 44A and 44B is made of material having excellent corrosion resistance such as metals including stainless steel and ceramics. Alternatively, each of the diaphragms 44A and 44B may be made of single crystal materials such as quartz crystal or other non-crystal materials. Each of the metal diaphragms 44A and 44B made of metal base material is produced by pressing. Each of the diaphragms 44A and 44B made of quartz crystal is produced by photolitho-etching such that the deforming portion 48 becomes thinner than the other portions.

Each of the surfaces of the diaphragms 44A and 44B exposed to the outside may be coated with a corrosion-resistant film so as to avoid corrosion by liquid, gas or the like. For example, the diaphragms 44A and 44B made of metal may be coated with nickel compound. When the diaphragms 44A and 44B are made of piezoelectric crystal material such as quartz crystal, they may be coated with silicon.

The center shaft 52 functioning as a force transmitting member connects the diaphragm 44A and the diaphragm 44B. The center shaft 52 is disposed within the housing 12 and lengthened in the Z axis direction. One end of the center shaft 52 in the longitudinal direction is connected with the center portion 46 of the diaphragm 44A, while the other end of the center shaft 52 is connected with the center portion 46 of the diaphragm 44B. It is preferable that the center shaft 52 is made of ceramic or the like which has a certain degree of rigidity and a small thermal expansion coefficient similarly to the material of the support shafts 36.

A fixing member 54 is attached to the center of the center shaft 52. The fixing member 54 has a through hole 56 through which the center shaft 52 is inserted in the Z axis direction for connection with the fixing member 54. According to this structure, the fixing member 54 shifts in the Z axis direction in accordance with the shift of the center shaft 52 in the Z axis direction. A second base 64 (described later) of the force detection element 58 is connected with the side surface of the fixing member 54. It is preferable that the portion of the boss 28 to which the force detection element 58 is attached is leveled with the portion of the fixing member 54 to which the force detection element 58 is attached. In this case, the force detection element 58 does not deform at the time of attachment of the force detection element 58 to the boss 28 and the fixing member 54, which reduces measurement errors of pressure values produced by deformation of the force detection element 58.

The force detection element 58 is made of piezoelectric material such as quartz crystal, lithium niobate, and lithium tantalate, and has vibrating arms 60 functioning as a force detection unit, and the first base 62 and the second base 64 provided at one ends and the other ends of the vibrating arms 60, respectively. The first base 62 is connected with the side surface of the boss 28, while the second base 64 is connected with the side surface of the fixing member 54. Thus, the force detection element 58 is joined with the housing 12 (container) via the boss 28, and further with the center shaft 52 as the force transmitting member via the fixing member 54. The longitudinal direction (Z axis direction) of the force detection element 58, that is, the direction where the first base 62 and the second base 64 face to each other is so determined as to be coaxial or parallel with the shift direction (Z axis direction) of the center shaft 52, the diaphragm 44A, and the diaphragm 44B. This shift direction corresponds to the detection axis.

Each of the vibrating arms 60 of the force detection element further has an exciting electrode (not shown) and an electrode unit (not shown) electrically connected with the exciting electrode (not shown). The electrode unit (not shown) of the force detection element 58 electrically connected with the IC (not shown) via the hermetic terminal 38 and the wire 40 oscillates at the natural resonance frequency when receiving alternating voltage from the IC (not shown). The resonance frequency of the force detection element 58 varies when an expanding stress or a compressing stress is applied to the force detection element 58 in the longitudinal direction thereof (Z axis direction).

According to this embodiment, the vibrating arms 60 functioning as the force detection unit may be constituted by a dual tuning fork resonator. The dual tuning fork resonator has such a characteristic that its resonance frequency changes substantially proportional to a pulling stress (expanding stress) or a compressing stress applied to the two oscillation beams corresponding to the vibrating arms 60. A double-ended tuning fork vibrator whose resonance frequency more greatly changes in a wider variable resonance frequency range in response to the expanding or compressing stress than a thickness-shear mode resonator or the like is suited for a force detector requiring high resolution necessary for detecting a slight difference of physical quantities (pressure difference). The resonance frequency of the vibrating arms 60 constituted by the dual tuning fork resonator increases when an expanding stress is applied thereto, and decreases when a compressing stress is applied thereto.

Moreover, the force detection unit according to this embodiment may be constituted not only by a detection unit which has two column-shaped vibrating beams but also by a detection unit which has only one vibrating beam (single beam). In the case of the force detection unit (oscillation arm) constituted by the single-beam-type resonator, the displacement of the detection unit becomes twice larger than that of the double-ended tuning fork vibrator when the same stress is applied to these resonators in the longitudinal direction (detection axis direction). Therefore, the force detector including the single-beam-type resonator can detect a physical quantity with higher sensitivity than the force detector provided with the dual tuning fork resonator.

According to this embodiment, the center shaft 52 shifts in the +Z axis direction when the force (pressure) applied to the diaphragm 44A is larger than the force (pressure) applied to the diaphragm 44B. In this case, the force detection element 58 receives a compressing stress in the Z axis direction, whereby the resonance frequency decreases. On the other hand, when the force (pressure) applied to the diaphragm 44A is smaller than the force (pressure) applied to the diaphragm 44B, the center shaft 52 shifts in the −Z axis direction. In this case, the force detection element 58 receives a pulling force in the Z axis direction, whereby the resonance frequency increases.

It is preferable that the piezoelectric substrate for the double-ended tuning fork vibrator is made of quartz crystal having excellent temperature characteristics among the above-described piezoelectric materials. In the case of the force detection element constituted by quartz crystal, it is preferable that the force detection element is produced by photolitho-etching as noted above.

For assembly of the force detector 10 in the first embodiment, the diaphragm 44A is initially connected with the first cover 14. Similarly, the diaphragm 44B is connected with the second cover 24 (provided with the hermetic terminal 38). Then, the support shafts 36 are fitted into the holes 32 of the first cover 14 for connection therewith, simultaneously with connection between one end of the center shaft 52 (provided with the fixing member 54) and the center portion 46 of the diaphragm 44A. After the center shaft 52 is inserted through the insertion hole 30 of the second cover 24, the other end of the center shaft 52 is connected with the center portion 46 of the diaphragm 44B. At this time, the support shafts 36 are also fitted into the holes 34 of the second cover 24 for connection therewith.

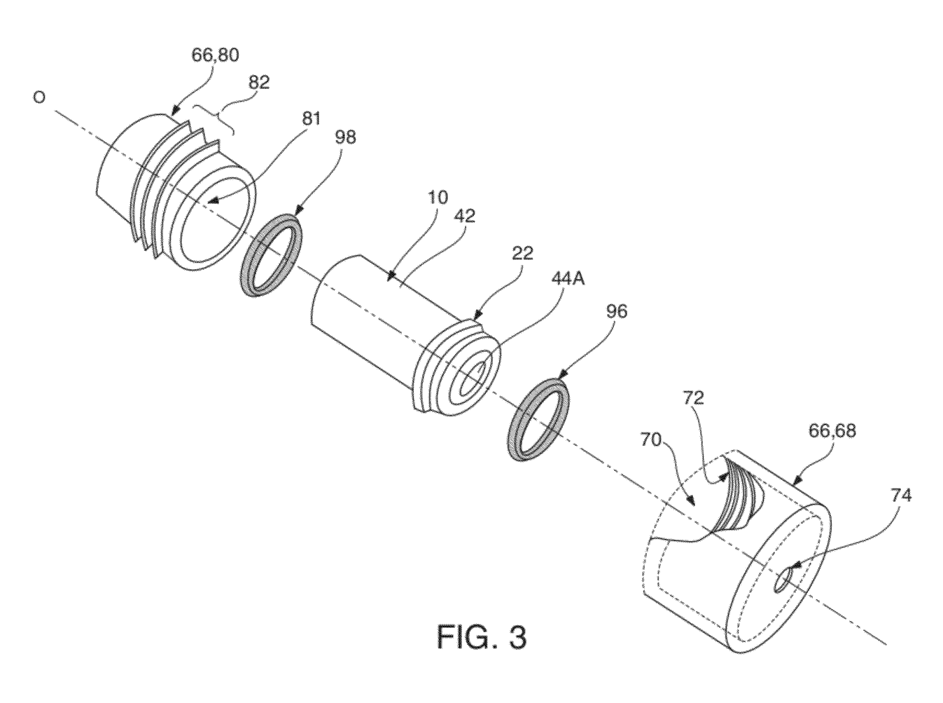

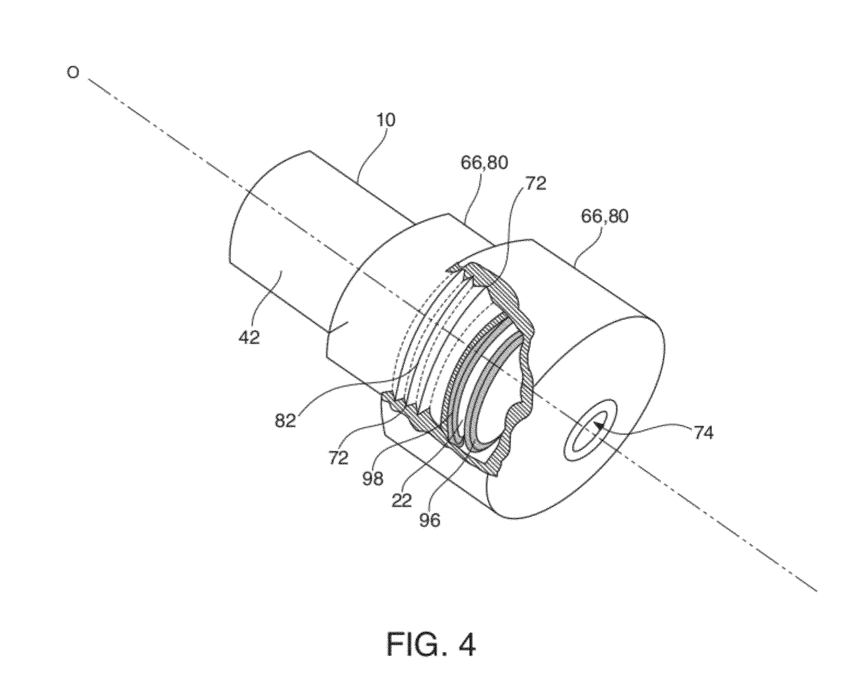

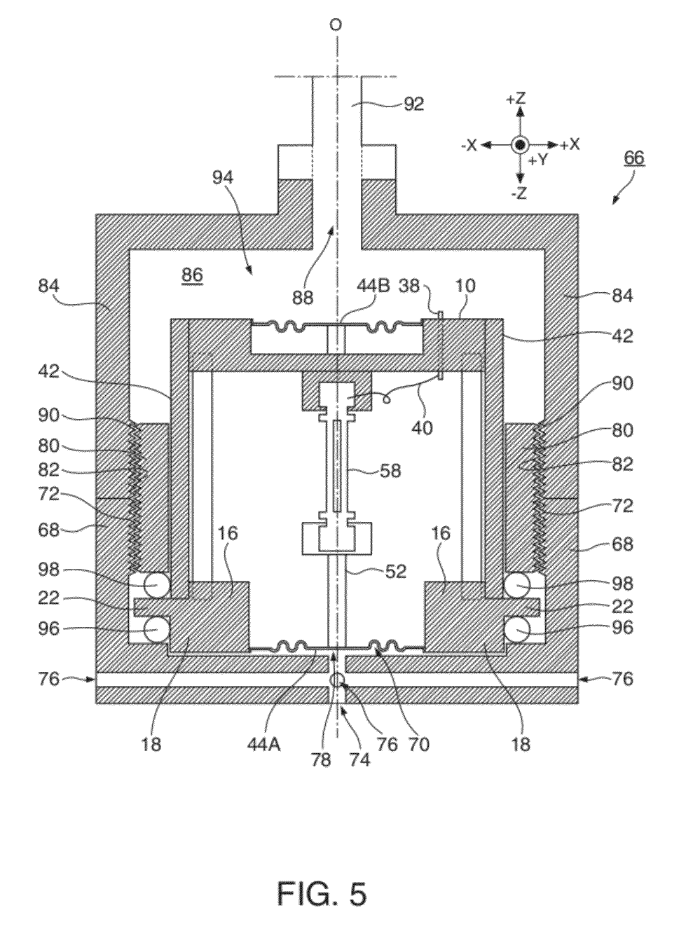

Then, the first base 62 of the force detection element 58 is connected with the side surface of the boss 28 of the second cover 24, while the second base 64 is connected with the side surface of the fixing member 54. After these connections, the electrode unit (not shown) of the force detection element 58 is joined with the hermetic terminal 38 via the wire 40. Finally, the structure having the external shape defined by the first cover 14, the second cover 24, the support shafts 36 and others is inserted through the cylindrical side wall 42, whereafter the side wall 42 is joined with the first cover 14 (flange 22) and the second cover 24 to produce the complete body of the force detector 10. For evacuation of the interior of the housing 12 of the force detector 10, the attachment between the structure to be inserted and the side wall 42 is carried out within a vacuum chamber. Alternatively, the interior of the container may be sucked for evacuation through a sealing hole (not shown) formed in the side wall 42 after connection with the side wall 42, which hole (not shown) will be sealed by a sealing member (not shown) after evacuation. FIG. 3 is a perspective view of the force detector and an external case for accommodating the force detector in a disassembled condition according to the first embodiment. FIG. 4 is a perspective view of the force detector accommodated in the external case according to the first embodiment. FIG. 5 is a cross-sectional view of the force detector accommodated in the external case according to the first embodiment. An external case 66 for accommodating the force detector 10 includes a first external case 68, a second external case 84 (not shown in FIGS. 3 and 4, see FIG. 5), and a screw fitting 80, and has a cylindrical shape with its center located on the line segment O similarly to the force detector 10. A circular ring 96 (O-ring), and a circular ring 98 (O-ring) are disposed on the flange of the force detector 10 (see FIG. 1). The first external case 68 has a concave 70 in which the area of the force detector 10 around the diaphragm 44A is accommodated, and a female screw 72 formed on the opening of the concave 70 for engagement with the screw fitting 80. A pressure introduction port 74 elongated in the Z axis direction is formed at the center of the bottom of the concave 70 of the first external case 68. Discharge ports 76 are further formed on the side surface of the bottom of the concave 70 of the first external case 68 and extended therefrom to communicate with the pressure introduction port 74. The discharge ports 76 are so arranged as to form a cross shape with its center located at the pressure introduction port 74 as viewed in the Z axis direction. The pressure introduction port 74 and the discharge ports 76 may be formed by drilling.

As illustrated in FIG. 5, the second external case 84 has a concave 86 in which the area of the force detector 10 around the diaphragm 44B is accommodated. A female screw 90 is formed on the opening of the concave 86 for engagement with the screw fitting 80. An open hole 88 is provided at the center of the concave 86 of the second external case 84. The open hole 88 is connected with a hollow tube 92.

The screw fitting 80 has an insertion hole 81 (see FIG. 3) having a diameter equal to or larger than the diameter of the side wall 42 and equal to or smaller than the diameter of the flange 22 so that the side wall 42 can be inserted through the insertion hole 81. The screw fitting 80 has a cylindrical shape so configured as to contact the flange 22. The screw fitting 80 as a component accommodated in the first external case 68 and the second external case 84 has a male screw 82 on the outside surface of the side wall of the screw fitting 80 for engagement with the female screws 72 and 90 formed on the inner walls of the respective external cases 68 and 84. It is assumed that no leakage of liquid or gas is produced from the space between the male screw 82 and the female screws 72 and 90 (see FIG. 5) under the condition of engagement between the male screw 82 and the female screws 72 and 90.

As illustrated in FIGS. 1 and 5, the circular ring 96 (O-ring) is a ring-shaped elastic body having such a size as to be fitted with the outer circumference of the second outer circumferential portion 18. Similarly, the circular ring 98 (O-ring) is a ring-shaped elastic body having such a size as to be fitted with the outer circumference of the side wall 42. The diameters of the cross sections of the circular ring 96 and the circular ring 98 agree with each other. According to this embodiment, the outer circumference of the side wall 42 and the second outer circumferential portion 18 have the same diameter, wherefore the diameters of the inner circumferences of the circular ring 96 and the circular ring 98 agree with each other.

When the screw fitting 80 is screwed into the first external case 68, the circular ring 96 is brought into press contact with the flange 22 and the bottom surface of the concave 70. Simultaneously, the circular ring 98 is brought into press contact with the flange 22 and the surface of the screw fitting 80 facing to the flange 22. In this condition, the respective circular rings 96 and 98 deform by compression. As a result, an internal space 78 defined by the first external case 68, the force detector 10 (diaphragm 44A), and the circular ring 96 is produced by the press contact between the circular ring 96 and the portions of the flange 22 and the concave 70 as illustrated in FIG. 5. Similarly, an internal space 94 defined by the second external case 84, the force detector 10 (diaphragm 44B), and the circular ring 98 is produced by the press contact between the circular ring 98 and the portions of the flange and the screw fitting 80. Accordingly, the pressure environments of the diaphragm 44A and the diaphragm 44B can be separated from each other via the circular rings 96 and 98. For example, the diaphragm 44B and the internal space 94 formed by the second external case 84, the force detector 10, and the circular ring 98 can contact a reference physical quantity measurement environment (such as pressure environment of atmospheric pressure) when one end of the tube 92 is opened to the reference pressure environment (atmospheric pressure). In this case, the wire 40 connected with the hermetic terminal 38 is inserted through the open hole 88 and the tube 92 and connected to the IC (not shown). On the other hand, the diaphragm 44A and the internal space 78 formed by the first external case 68, the force detector 10, and the circular ring can contact a physical quantity measurement target environment (pressure measurement target environment) as a measurement target when the pressure introduction port 74 and the discharge ports 76 are opened to the pressure measurement target environment (such as water pressure).

According to the force detector 10 contained in the external case 66, therefore, the flange 22 is held between the circular ring 96 and the circular ring 98. In this arrangement, the flange 22 is distorted by the compression in the Z axis direction produced by the holding forces of the circular rings 96 and 98. This distortion generates a stress which may reach the diaphragm 44A. In the case of the flange 22 constructed as above, however, the −Z axis side end surface of the second outer circumferential portion 18 where the diaphragm 44A is provided, and the +Z axis side end surface of the second cover 24 where the diaphragm 44 is disposed are located at the positions projected away from the flange 22 in the thickness direction of the flange 22 (Z axis direction). According to this structure, the distance between the flange 22 and the diaphragm 44A becomes larger than the corresponding distance in a structure which locates the flange 22 and the diaphragm 44A in the same plane. In this case, the stress generated by the forces of the circular rings 96 and 98 for holding the flange is decreased by the time when the stress reaches the diaphragm 44A. Accordingly, the force detector 10 can reduce deterioration of the sensitivity for detecting the condition of the diaphragm 44A (pressure receiving condition) caused by the fixation between the force detector 10 and the external case 66 via the flange 22.

For introducing the force detector 10 accommodated in the external case 66 into water for water pressure measurement, it is necessary to discharge the air remaining in the internal space 78 defined by the first external case 68, the force detector 10, and the circular ring 96 to the outside. The pressure introduction port 74 is provided as an opening small enough to avoid mechanical damage which may be given to the diaphragm 44A by collision with rocks or the like existing in the water. According to this structure, when the force detector 10 accommodated in the external case 66 is introduced into the water, the air within the internal space 78 is difficult to be discharged due to the small size of the pressure introduction port 74. In this embodiment, however, the discharge ports 76 communicating with the pressure introduction port 74 can efficiently discharge the air remaining in the internal space 78 disposed between the external case 66 and the force detector 10 at the time of introduction of the force detector 10 into liquid (water). According to the structure in this embodiment, the first cover 14 and the flange 22 are formed integrally with each other. Thus, the entire strength of the force detector 10 can be maintained. Moreover, the integral structure of the first cover 14 and the flange 22 can decrease the volume of the clearance between the force detector 10 and the external case 66, that is, the volume of the internal space 78 (see FIG. 5) and easily discharges the air remaining in the internal space 78 to the outside at the time of introduction of the force detector 10 into liquid so as to reduce measurement errors of the pressure.

The flange 22 of the force detector 10 is held by the circular ring 96 and the circular ring 98. It is preferable, however, that the first external case 68, the second external case 84, and the screw fitting 80 are designed in such shapes as not to directly contact the force detector 10.

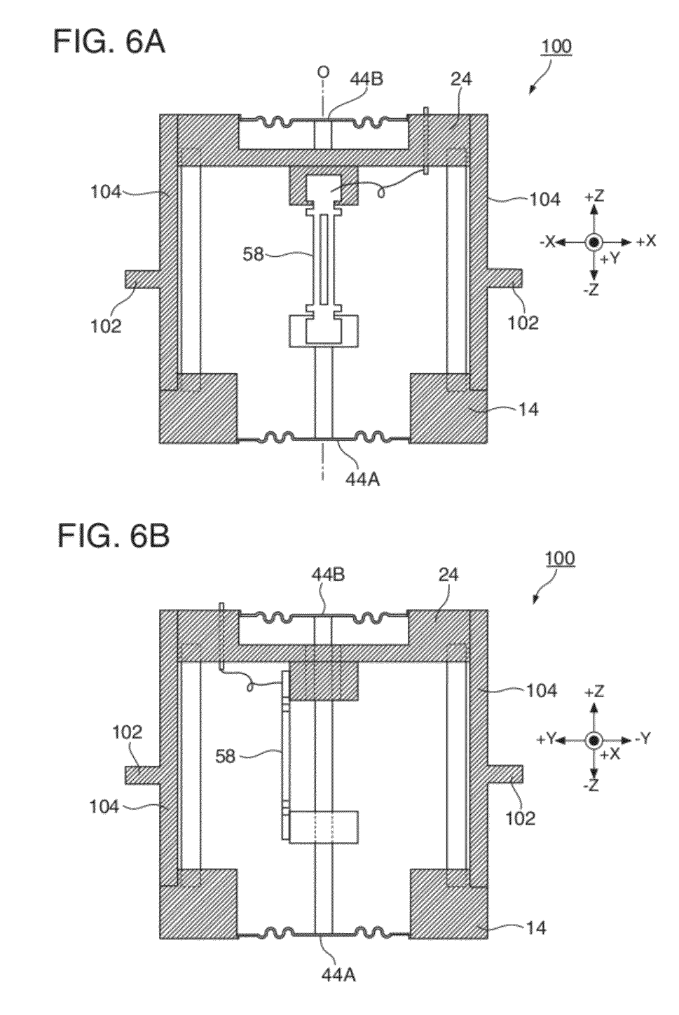

FIGS. 6A and 6B are cross-sectional views of a force detector according to a second embodiment. FIG. 6A is across-sectional view taken along the XZ plane, while FIG. 6B is a cross-sectional view taken along the YZ plane.

A force detector 100 in the second embodiment is basically similar to the force detector 10 in the first embodiment, but is different therefrom in that a flange 102 is positioned at the center of the side surface of the container, that is, at the center of a side wall 104.

When the diaphragm 44B as the second diaphragm is disposed on the second cover 24 corresponding to the end surface of the container facing to the diaphragm 44A as in this embodiment, the distance between the diaphragm 44A and the flange 102 becomes equal to the distance between the diaphragm 44B and the flange 102. In this case, the stress generated by the hold of the flange 102 via the circular rings 96 and 98 is not one-sidedly transmitted to one of the diaphragms 44A and 44B. Moreover, since the flange 102 is located at the center of the side surface of the container, that is, at the center of the side wall 104, the stress produced by the hold of the flange 102 can be sufficiently decreased by the time when the stress reaches the respective diaphragms 44A and 44B. Accordingly, the force detector 100 can highly accurately reduce deterioration of the diaphragm deformation sensitivity (pressure receiving sensitivity) caused by fixation between the force detector 100 and the external case (not shown) via the flange.

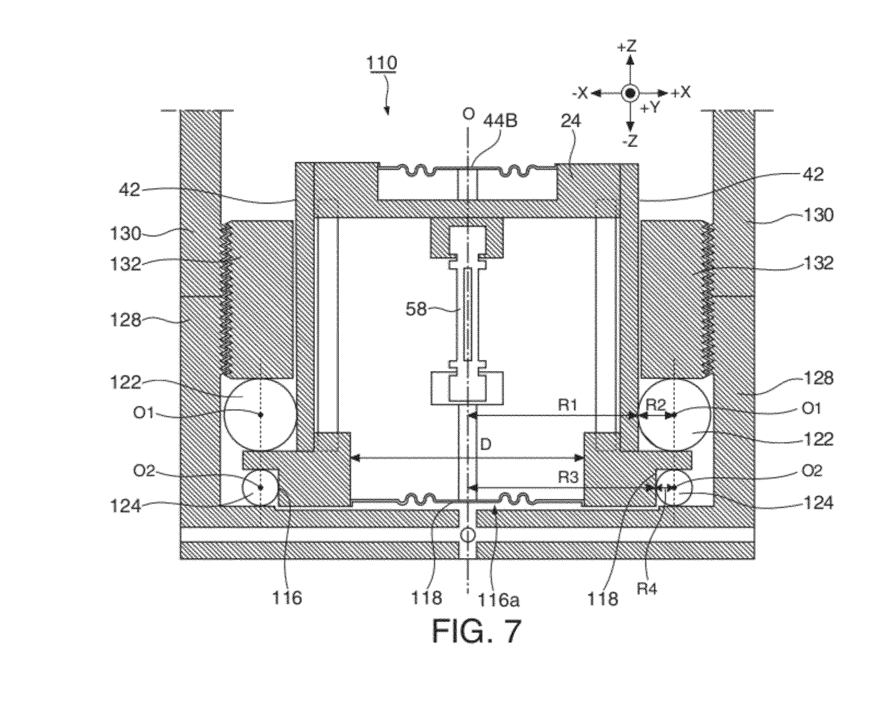

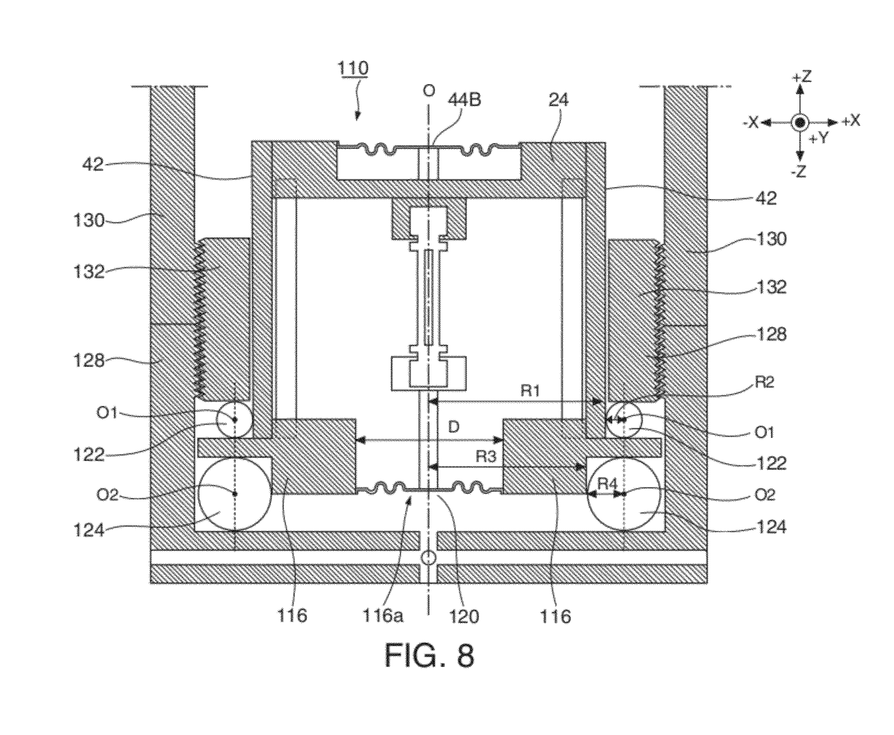

FIGS. 7 and 8 are cross-sectional views of a force detector according to a third embodiment. FIG. 7 is a cross-sectional view (taken along the XZ plane) of the force detector designed such that the diameter of the first outer circumferential portion is larger than the diameter of the side wall. FIG. 8 is a cross-sectional view (taken along the XZ plane) of the force detector designed such that the diameter of the first outer circumferential portion is smaller than the diameter of the side wall.

A force detector 110 in the third embodiment is basically similar to the force detector 10 in the first embodiment, but is different therefrom in that the diameter of the side surface of the housing 12 on the one surface side of a flange 112 (side wall 42 side) is different from the diameter of the other surface side of the housing 12 on the side opposed to the one side surface of the flange 112 (second outer circumferential portion 116 side). In other words, the diameter of the outer circumference of the second outer circumferential portion 116 disposed on the −Z axis side of the flange 112 is different from the diameter of the outer circumference of the side wall 42 disposed on the +Z axis side of the flange 112. Generally, the design of the diameter of a diaphragm varies according to the measurement target pressure and environment. Thus, the diameter of the cover to which the diaphragm is attached, that is, the inside diameter of the second outer circumferential portion 116 (diameter D of opening 116a) changes accordingly. When a low pressure is measured, for example, the diameter of a diaphragm 118 is made large as illustrated in FIG. 7. On the other hand, when a high pressure is measured, the diameter of a diaphragm 120 is made small as illustrated in FIG. 8. Therefore, the diameter of the external shape of the second outer circumferential portion 116 is varied according to the design of the opening 116a.

According to this embodiment, however, the second cover 24, the diaphragm 44B, and the side wall 42 are constituted by components having standardized sizes. Thus, the cost of the force detector 110 can be reduced even when the diaphragm design is varied for each measurement environment.

According to this embodiment, a first circular ring 122 is disposed on the surface of the flange 112 on the side wall 42 side, while a second circular ring 124 is disposed on the surface of the flange 112 opposite to the surface contacting the first circular ring 122, that is, the surface on the second outer circumferential portion 116 side.

The diameter of the first circular ring 122 and the diameter of the second circular ring 124 are designed such that the sum of a radius R2 of the cross section of the first circular ring 122 and a radius R1 of the side wall 42 becomes equal to the sum of a radius R4 of the cross section of the second circular ring 124 and a radius R3 of the outer circumference of the second circumferential portion 116.

According to this structure, a center O1 of the cross section of the first circular ring 122 is disposed to be opposed to a center O2 of the cross section of the second circular ring 124 with the flange 112 interposed between the centers O1 and O2. A line connecting the centers O1 and O2 becomes parallel with the Z axis, and thus corresponds to the normal lines of both the surfaces of the flange 112. This structure decreases a stress generated by the hold of the flange 112 via the first circular ring 122 and the second circular ring 124 and deforming the entire area of a first cover 126 as a cover and the entire areas of the diaphragms 118 and 120. Similarly to the above embodiments, the force detector 110 in the third embodiment can be accommodated in an external case when the sizes and the like of a first external case 128, a second external case 130, and a screw fitting 132 are appropriately changed from the sizes and the like of the corresponding components in the above embodiments.

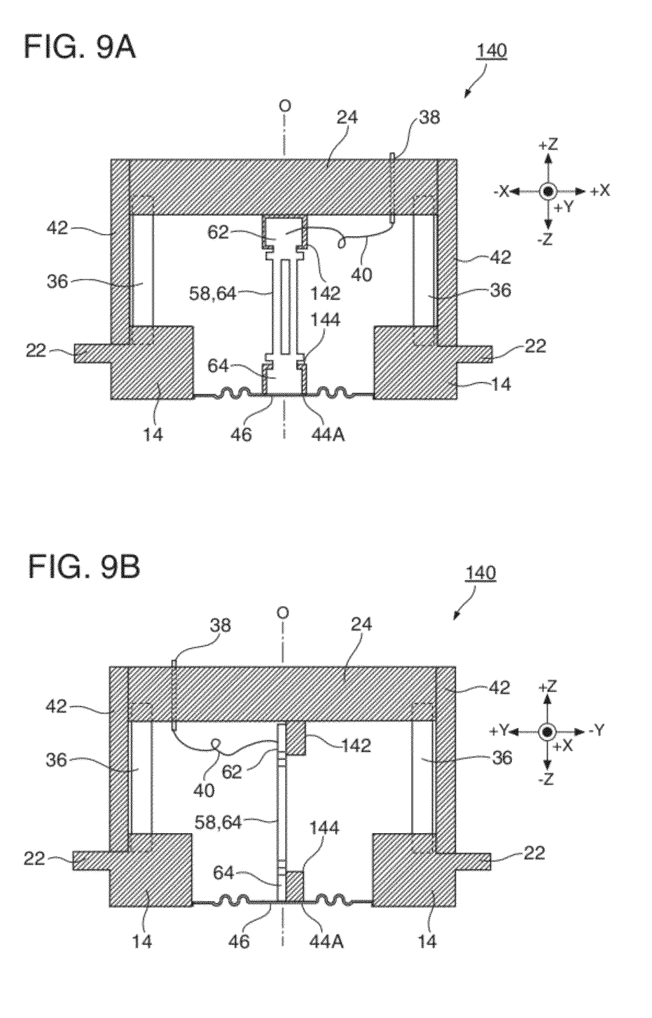

FIGS. 9A and 9B are cross-sectional views of a force detector according to a fourth embodiment. FIG. 9A is across-sectional view taken along the XZ plane, while FIG. 9B is a cross-sectional view taken along the YZ plane. According to a force detector 140 in the fourth embodiment, the diaphragm 44A is disposed on the first cover 14, but the diaphragm 44B is not provided on the second cover 24. In addition, the center shaft 52 as the force transmitting unit is eliminated, wherefore the force detection element 58 is directly connected with the diaphragm 44A. Accordingly, the force detector 140 in this embodiment can measure an absolute pressure based on the air pressure (such as vacuum) within the housing 12 as a reference pressure.

The first base 62 of the force detection element 58 is connected with the second cover 24 via a fixing member 142. The second base 64 of the force detection element 58 is fixed to the center of the diaphragm 44A. The connection strength between the second base 64 and the diaphragm 44A is reinforced by a fixing member 144 fixed to the center portion 46. According to this structure, the force detection element 58 receives a force from the diaphragm 44A without intervention of the center shaft 52, which increases the sensitivity of the force detection element for detecting the pressure difference between the diaphragms.

For assembly of the force detector 140 in this embodiment, the diaphragm 44A and the fixing member 144 are initially connected with the first cover 14, while the fixing member 142 is connected with the second cover 24. Then, the first cover 14, the support shafts 36, and the second cover 24 are assembled. After assembly of these components, the force detection element 58 is connected with the fixing member 142 and the fixing member 144, and also electrically connected with the hermetic terminal 38 via the wire 40. Finally, the side wall 42 is joined with the first cover 14 and the second cover 24 under a vacuum environment, for example, to produce a complete body of the force detector 140 having the evacuated and sealed interior space within the housing 12. According to this embodiment and the following embodiments, the advantages provided by the structure of the flange 22 and the diaphragm 44A are similar to those of the first embodiment, and therefore are not repeatedly explained.

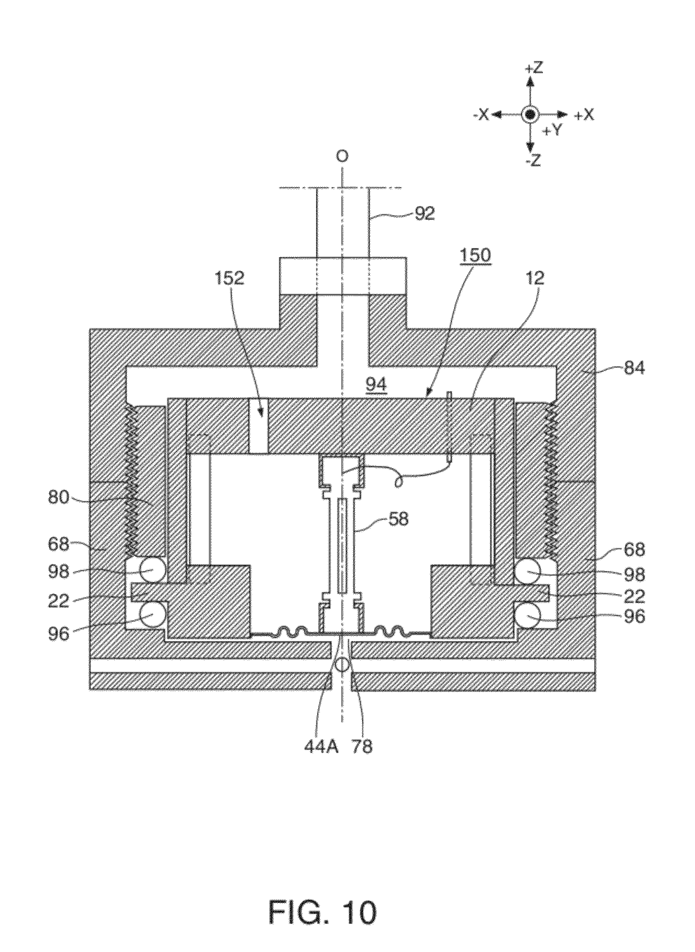

FIG. 10 is a cross-sectional view of a force detector according to a modified example of the fourth embodiment. As illustrated in FIG. 10, a force detector 150 in this modified example has a pressure introduction port 152 additionally formed in the second cover 24 of the force detector 140 in the fourth embodiment as a through hole penetrating the second cover 24 in the thickness direction thereof (Z axis direction). When the force detector 150 is accommodated within the first external case 68, the second external case 84 and others, the interior of the housing 12 is opened to the internal space 94 defined by the second external case 84 via the pressure introduction port 152. In this case, a pressure is applied to the surface (+Z axis side surface) of the diaphragm 44A opposite to the pressure receiving surface (−Z axis side surface) of the diaphragm 44A from a reference pressure environment (such as atmospheric pressure environment) as the connection target of the tube 92. According to this modified example, therefore, the pressure of the pressure measurement target environment (pressure in the internal space 78) applied to the pressure receiving surface of the diaphragm 44A can be measured based on the pressure of the reference pressure environment.

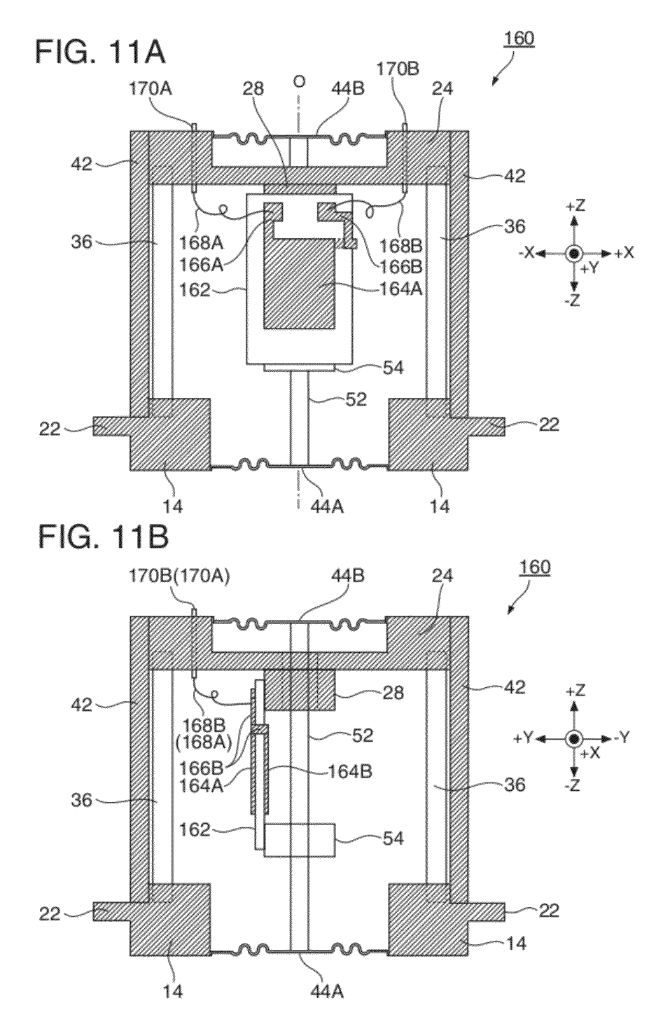

FIGS. 11A and 11B are cross-sectional views of a force detector according to a fifth embodiment. FIG. 11A is a cross-sectional view taken along the XZ plane, while FIG. 11B is a cross-sectional view taken along the YZ plane. As illustrated in FIGS. 11A and 11B, a force detector 160 in this embodiment has a shape substantially similar to that of the force detector in the first embodiment as a whole, but includes a thickness-shear mode resonator constituted by an AT cut quartz crystal substrate as a force detection element 162. The force detection element 162 having a rectangular shape on the whole has an exciting electrode 164A disposed at the center of one main surface of the force detection element 162 (+Y axis side surface), and an exciting electrode 164B disposed on the other main surface of the force detection element 162 (−Y axis side surface) at the position opposed to the exciting electrode 164A.

An extension electrode 166A and an extension electrode 166B are further provided on the +Z axis side of the one main surface of the force detection element 162. The extension electrode 166A as a component extended from the exciting electrode 164A is electrically connected with the exciting electrode 164A. The extension electrode 166B is extended from the exciting electrode 164B through the end surface of the quartz crystal substrate (+X axis side surface) provided therebetween, and is electrically connected with the exciting electrode 164B. The extension electrode 166A is electrically connected with a hermetic terminal 170A via a wire 168A, while the extension electrode 166B is electrically connected with a hermetic terminal 170B via a wire 168B. In this arrangement, the exciting electrode 164A is electrically connected with the IC (integrated circuit, not shown) disposed outside the force detector 160 via the extension electrode 166A, the wire 168A, and the hermetic terminal 170A, while the exciting electrode 164B is electrically connected with the IC (not shown) via the extension electrode 166B, the wire 168B, and the hermetic terminal 170B. When alternating voltage is applied from the IC (not shown) to the exciting electrode 164A and the exciting electrode 164B in this structure, the force detection element 162 generates thickness-shear mode oscillation at a predetermined resonance frequency chiefly in the area sandwiched between the exciting electrode 164A and the exciting electrode 164B.

Moreover, the +Z axis side of the other chief surface of the force detection element 162 (−Y axis side surface) is supported by the boss 28, while the −Z axis side of this surface is supported by the fixing member 54 fixed to the center shaft 52. According to this structure, the center shaft 52 shifts in the direction of the resultant force of the forces received from the diaphragms 44A and 44B (Z axis direction). In this case, the force detection element 162 receives a stress produced by the shift of the center shaft 52, whereby the resonance frequency changes. Accordingly, the force detector 160 can determine a pressure (relative pressure) based on the measurement of the change of the resonance frequency.

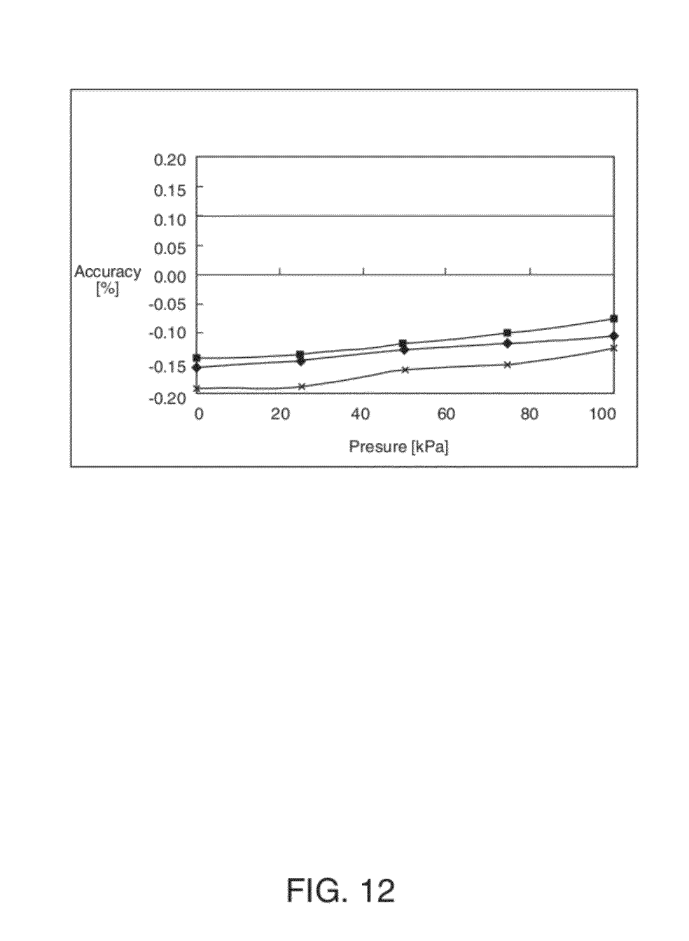

FIG. 12 shows the change of the pressure value after attachment and detachment of a force detector to and from an external case for each predetermined environmental temperature in a related art. In FIG. 12, the vertical axis indicates the amount of change (%), while the horizontal axis indicates applied pressure (kPa). The environmental temperature of the force detector is set at −10° C., +10° C., +25° C., and +50° C.

The present inventors examined the change of the pressure value after the pressure sensor in the related art such as those disclosed in JP-A-2010-019826 and other references accommodated in the external case is removed from the external case and again inserted into the external case. According to the findings of the inventors, the pressure value greatly changes after the re-attachment regardless of the applied pressure as can be seen from FIG. 12. Also, the error of the pressure value increases as the applied pressure decreases. This tendency is true for each of different temperatures. It can be concluded from these facts that a certain amount of stress is applied to the diaphragm at the time of re-insertion regardless of the applied pressure. Thus, the pressure sensor (force detector) in the related art requires zero-point adjustment of the pressure value every time the pressure sensor is inserted into the external case.

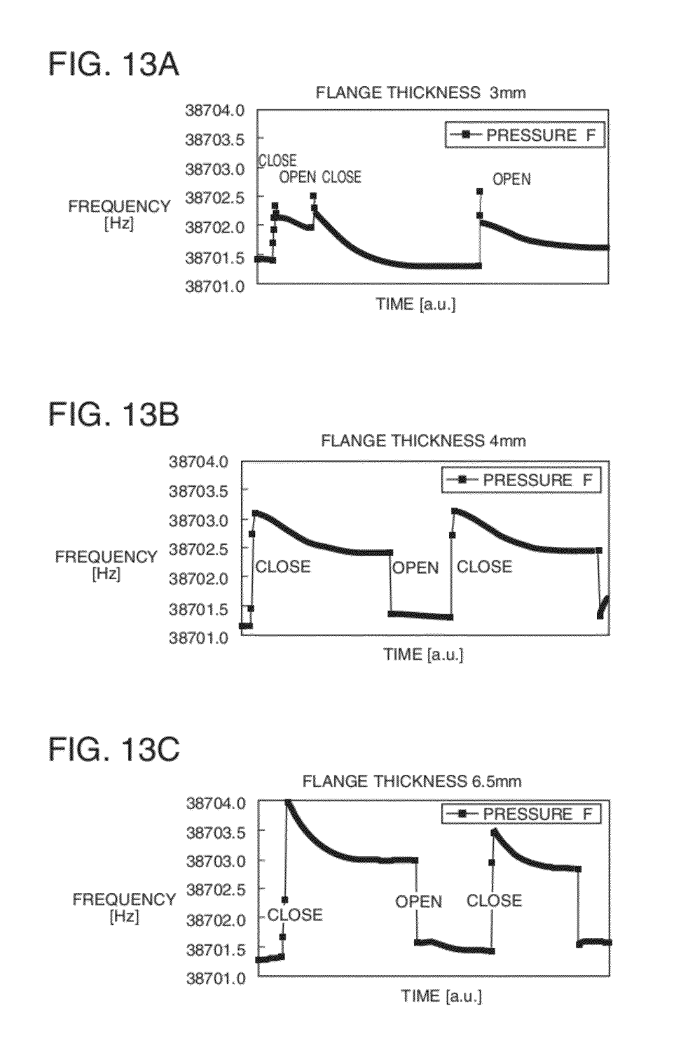

FIGS. 13A through 13C show the change of the resonance frequency (change of pressure value) of the force detector with an elapse of time after attachment and detachment of the force detector to and from the external case for each thickness of the flange in the related art. FIG. 13A corresponds to the change when the thickness of the flange is 3 mm. FIG. 13B corresponds to the change when the thickness of the flange is 4 mm. FIG. 13C corresponds to the change when the thickness of the flange is 6.5 mm. In FIGS. 13A through 13C, the vertical axis indicates the frequency (Hz), while the horizontal axis indicates the time (a. u.).

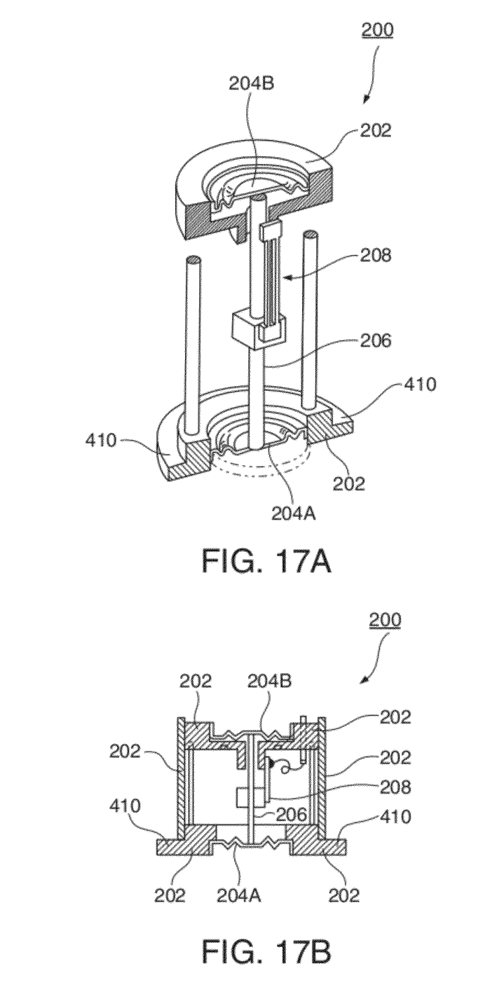

The present inventors examined the change of the resonance frequency with the elapse of time when the force detector is repeatedly attached to and detached from the external case for each of the 3 mm thick flange, 4 mm thick flange, and 6.5 mm flange. The attachment and detachment of the force detector refers to the action for removing the force detector inserted in the external case after zero-point adjustment of the pressure value from the external case, and again inserting the force detector into the external case. For each of the flange thicknesses, the attachment position of the flange lies in the plane leveled with the plane formed by the diaphragm included in the force detector. The flange is held by the first external case, the second external case, and the screw fitting via the two circular rings as illustrated in FIGS. 17A and 17B and other figures. As can be seen from FIGS. 13A through 13C, the resonance frequency of the force detector rapidly increases at the time of hold of both the surfaces of the flange for each of the flange thicknesses. More specifically, the resonance increases by the maximum of approximately 1 Hz for the 3 mm thick flange, by the maximum of approximately 1.7 Hz for the 4 mm thick flange, and by the maximum of 2.7 Hz for the 6.5 mm flange.

Based on these facts, it can be concluded that a compressing stress in the thickness direction of the flange is generated by the hold of the flange via the circular rings (O-rings), and transmitted to the diaphragm. The amount of the change at the initial period becomes larger as the thickness of the flange increases. Accordingly, it can be estimated that the amount of the change of the flange thickness produced by the hold of the flange via the circular rings increases, wherefore the stress thus generated increases, as the thickness of the flange becomes larger. In each of the flange thicknesses, the resonance frequency of the force detector monotonously decreases with the elapse of time after the rise because the circular rings tightened by the screw fitting gradually deform into stable shapes or shift toward stable positions. According to the force detector (pressure sensor) in the related art, therefore, the stress transmitted to the diaphragm can be decreased by reduction of the thickness of the flange. However, reduction of the stress reaching the diaphragm is still insufficient when the distance between the diaphragm and the flange is short.

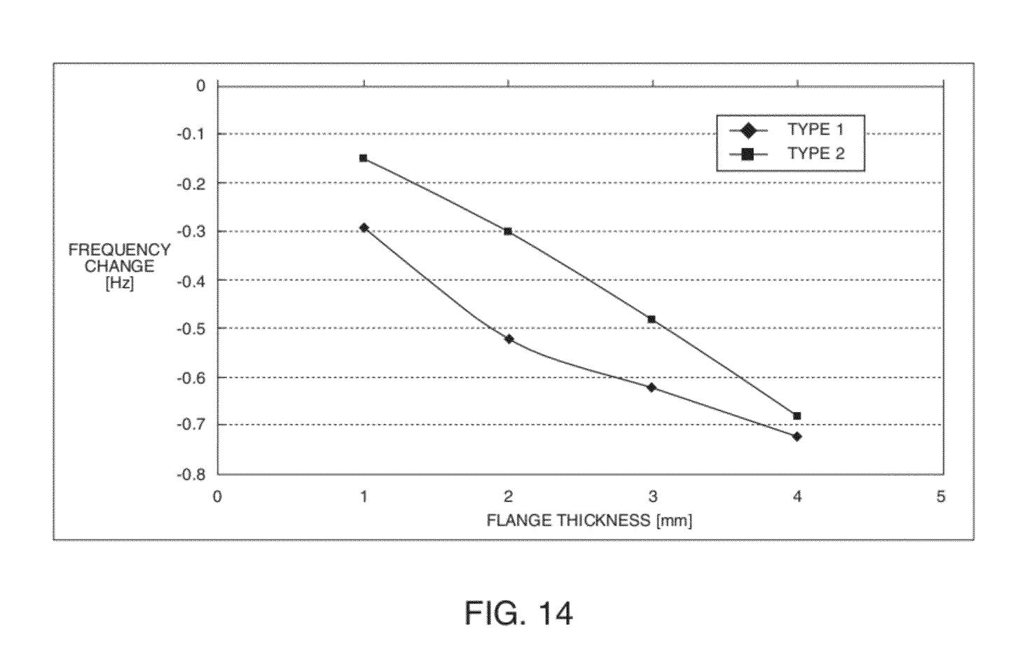

FIG. 14 shows a comparison between the force detector in the embodiments and the force detector in the related art in regard to the change of the resonance frequency (pressure value) of the sensor after the attachment and detachment of the force detector to and from the external case. In FIG. 14, the vertical axis indicates the amount of the frequency change (Hz), while the horizontal axis indicates the thickness of the flange (mm).

The present inventors examined the change of the resonance frequency of a force detector of the same type as the related-art force detector disclosed in JP-A-2010-019826 or other references (type 1) and a force detector of the same type as the force detector in the second embodiment of the invention (type 2) after repeated attachment to and detachment from the external case. Each of the types 1 and 2 has a cylindrical external shape having a diameter of 22 mm and a length of 40 mm. The diaphragm disposed at the lower end of the cylindrical external shape has a diameter of 13.5 mm. The flange of the type 1 is positioned at the lower end of the side surface of the external shape. The flange of the type 2 is disposed on the side surface of the external shape at such a position that the center of the flange in the thickness direction thereof is located away from the lower end of the side surface of the external shape by a distance of 20 mm (at the center of the side surface of the external shape). The change of the resonance frequency is examined for each of the sensors of the types 1 and 2 having the 4 mm thick flange, 3 mm thick flange, 2 mm thick flange, and 1 mm thick flange.

As can be seen from FIG. 14, the change of the resonance frequency of the type 2 is smaller than the corresponding change of the type 1 for each thickness. When the flange is 3 mm thick, for example, the change of the type 1 is 0.6 Hz. This difference increases as the thickness of the flange becomes smaller. Accordingly, it can be concluded that the stress reaching the diaphragm more greatly decreases in a structure which has a large distance between the diaphragm and the flange like the type 2 than the corresponding stress in the related art. Particularly when the flange is disposed at the center of the side surface of the force detector like the structure of the type 2, a more preferable effect can be recognized. Moreover, in the case of the force detector in the first embodiment which also has a larger distance between the diaphragm and the flange than the corresponding distance in the related art, it is estimated that the change of the resonance frequency produced by attachment and detachment of the force detector similarly decreases.

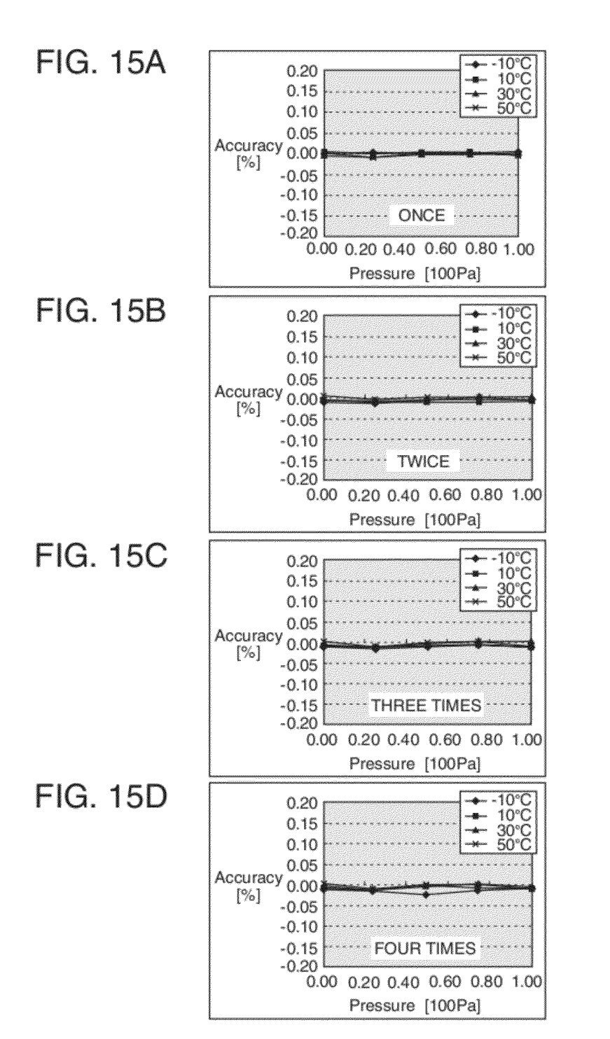

FIGS. 15A through 15D show the change of the pressure value after repeated attachment and detachment of the force detector to and from the external case for each of predetermined temperatures in the embodiments. FIG. 15A corresponds to the change resulting from the attachment and detachment performed once. FIG. 15B corresponds to the change resulting from the attachment and detachment performed twice. FIG. 15C corresponds to the change resulting from the attachment and detachment performed three times. FIG. 15D corresponds to the change resulting from the attachment and detachment performed four times. In each of FIGS. 15A through 15D, the vertical axis indicates the amount of change (%), while the horizontal axis indicates the applied pressure (100 Pa). In the respective figures, the environmental temperature of the force detector is set at −10° C., +10° C., +30° C., and +50° C.

The present inventors examined the change of the pressure value after repeated attachment and detachment of the force detector to and from the external case in the embodiments. As can be seen from FIGS. 15A through 15D, the change of the pressure value of the zero-point adjusted force detector before the attachment and detachment is extremely small even when the action for the attachment and detachment is repeated.

Accordingly, the structure in this embodiment can stabilize the pressure value even when the attachment and detachment action is repeated.

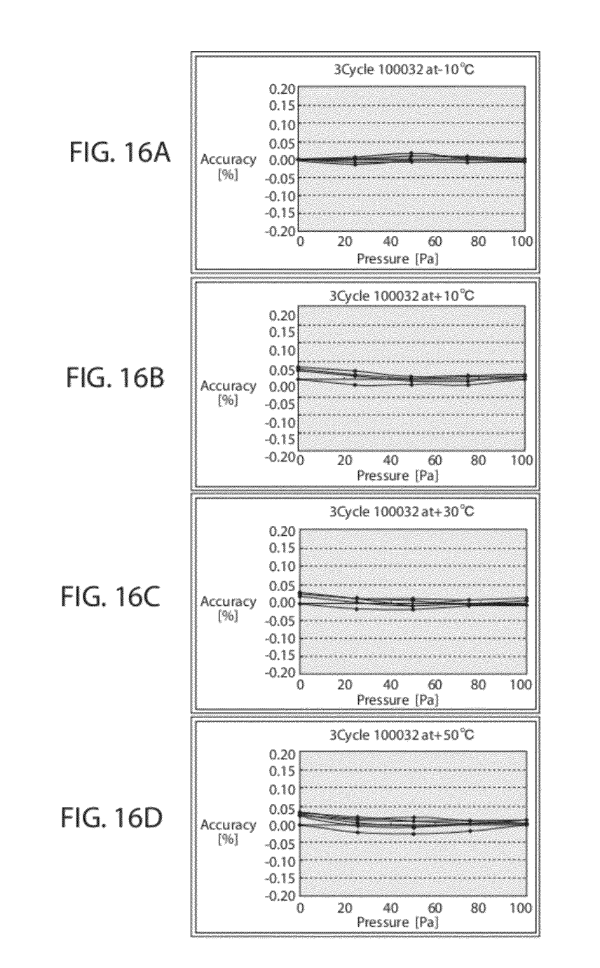

FIGS. 16A through 16D show the hysteresis characteristics of the force detector when attachment and detachment of the force detector to and from the external case are executed three times in this embodiment. FIG. 16A corresponds to the result at the environmental temperature of the force detector set at −10° C. FIG. 16B corresponds to the result at the environmental temperature of +10° C. FIG. 16C corresponds to the result at the environmental temperature of +30° C. FIG. 16D corresponds to the result at the environmental temperature of +50° C. In each of FIGS. 16A through 16D, the vertical axis indicates the amount of change (%), while the horizontal axis indicates the applied pressure (Pa).

The present inventors evaluated the change of the pressure value (hysteresis) of the force detector repeatedly attached and detached, produced from the condition before the pressure is applied to the force detector to the condition after the applied pressure is released. The evaluation proved that the hysteresis characteristics become preferable even when the environmental temperature and the applied pressure are varied as can be seen from FIGS. 16A through 16D. Accordingly, the force detector in the embodiments can provide stable pressure values while reducing variations of the pressure values caused by repeated attachment and detachment, and also avoid deterioration of the hysteresis characteristics.

In each of the embodiments described herein, the force detector capable of measuring relative physical quantities (relative pressures) by using the two diaphragms has been discussed. However, the technologies in the respective embodiments can be applied to a force detector which measures an absolute pressure by using only either one of the diaphragms based on vacuum as a reference while evacuating and sealing the interior of the container, for example. Furthermore, in the first embodiment and other embodiments, the first cover 14 has the first outer circumferential portion 16, the second outer circumferential portion 18, the opening 20, and the flange 22. On the other hand, the second cover 24 has the concave 26, the boss 28, and the insertion hole 30. However, the components 16, 18, 20, and 22 of the first cover 14 may be included in the second cover 24, while the components 26, 28, and 30 of the second cover 24 may be included in the first cover 14. The entire disclosure of Japanese Patent Application No. 2011-033921, filed Feb. 18, 2011 is expressly incorporated by reference herein.

1. A force detector comprising:
a container which has a cylindrical external shape;
a diaphragm which is disposed on an end surface of the container and shifts toward the inside or outside of the container when receiving a force;
a force detection element which has a force detection unit and a pair of bases connected with one and the other ends of the force detection unit, respectively, and detects a force generated by the shift of the diaphragm with the detection axis extending in the direction parallel with the line connecting the bases under the condition in which the one and the other bases are connected with the diaphragm and the container, respectively; and
a flange which projects from the side surface of the container in the direction toward the outer circumferential side of the side surface such that the flange becomes concentric with the outer circumference of the side surface of the container,
wherein the flange is disposed in such a position that the end surface of the container on which the diaphragm is provided projects in the thickness direction of the flange from the position of the flange.

2. The force detector according to claim 1, wherein the force detection element is disposed in such a position that the direction of the detection axis extends in parallel with the shift direction of the diaphragm.

3. The force detector according to claim 1, further comprising:
a second diaphragm disposed on the container at a position opposed to the diaphragm; and
a force transmitting member which connects the diaphragm and the second diaphragm and shifts in the direction of the resultant force of a force received from the diaphragm and a force received from the second diaphragm,
wherein the one base of the force detection element is connected with the force transmitting member.

4. The force detector according to claim 3, wherein the flange is disposed at the center of the side surface.

5. The force detector according to claim 3, wherein
the container includes
a cylindrical side wall which forms the side surface and has an opening on each of both the ends of the side wall, and
a first cover and a second cover each of which forms the corresponding end surface and seals the corresponding opening;
the diaphragm is disposed on the first cover;
the second diaphragm is disposed on the second cover; and
the flange is disposed on the side surface of either the first cover or the second cover, and is disposed in such a position that the end surface formed by the cover where the diaphragm is disposed projects in the thickness direction of the flange from the position of the flange.

6. The force detector according to claim 1, wherein the diameter of the outer circumference of the side surface on the side of the one surface of the flange is different from the diameter of the outer circumference of the side surface on the side of the other surface of the flange opposed to the one surface of the flange.

7. The force detector according to claim 6, further comprising:
a first circular ring contacting the one surface of the flange; and
a second circular ring contacting the other surface of the flange,
wherein the sum of the radius of the cross section of the first circular ring and the radius of the container on the side of the one surface of the flange is equal to the sum of the radius of the cross section of the second circular ring and the radius of the container on the side of the other surface of the flange.

8. The force detector according to claim 1, further comprising:
an external case which accommodates the container and has a pressure introduction port at a position opposed to the diaphragm,
wherein the external case has a discharge port extended from the side surface of the external case to a junction position with the pressure introduction port.

9. The force detector according to claim 2, further comprising:
a second diaphragm disposed on the container at a position opposed to the diaphragm; and
a force transmitting member which connects the diaphragm and the second diaphragm and shifts in the direction of the resultant force of a force received from the diaphragm and a force received from the second diaphragm,
wherein the one base of the force detection element is connected with the force transmitting member.

10. The force detector according to claim 2, wherein the diameter of the outer circumference of the side surface on the side of the one surface of the flange is different from the diameter of the outer circumference of the side surface on the side of the other surface of the flange opposed to the one surface of the flange.

11. The force detector according to claim 2, further comprising:
an external case which accommodates the container and has a pressure introduction port at a position opposed to the diaphragm,
wherein the external case has a discharge port extended from the side surface of the external case to a junction position with the pressure introduction port.
